(19) United States
(12) Patent Application Publication
(10) Pub. No.: US 2026/0151849 A1
(43) Pub. Date: Jun. 4, 2026

(54) METHOD FOR REPLACING A SET OF CUTTING PARAMETERS FOR PRODUCING A CUTTING EDGE BY MEANS OF A LASER CUTTING MACHINE WITH AN OPTIMISED SET OF CUTTING PARAMETERS, AND LASER CUTTING MACHINE

(71) Applicant: TRUMPF WERKZEUGMASCHINEN SE + CO. KG, Ditzingen (DE)

(72) Inventors: Aastha Aastha, Freiberg am Neckar (DE); Manuel Geiger, Möglingen (DE); Korbinian Weiß, Korntal (DE); Philipp Leube, Stuttgart (DE); Thomas Hert, Ditzingen (DE)

(21) Appl. No.: 19/457,188

(22) Filed: Jan. 23, 2026

Related U.S. Application Data
(63) Continuation of application No. PCT/EP2024/070413, filed on Jul. 18, 2024.

(30) Foreign Application Priority Data
Jul. 25, 2023 (DE) 10 2023 119 566.2

(51) Int. Cl. B23K 26/03; B23K 26/38; B23K 101/20

(52) U.S. Cl. CPC B23K 26/032; B23K 26/38; B23K 2101/20

(57) ABSTRACT

A method for replacing a set of parameters, the method including producing a cutting edge with a laser cutting machine using a set of parameters. The cutting edge has a machining error. The machining error is classified according to a type. Several modified sets of parameters are generated based on the classification. Further cutting edges are produced using the modified sets of parameters. Each modified set of parameters is used to produce one further cutting edge. The method includes creating an evaluation of the further cutting edges by rating an occurrence of machining errors for each, ascertaining which of the further cutting edges was evaluated as best, and replacing the set of parameters with the optimized set of parameters. The optimized set of parameters is based on the modified set of parameters with which the ascertained further cutting edge that was evaluated as best was produced.

### CROSS REFERENCE TO RELATED APPLICATIONS

This application is a continuation of International Application No. PCT/EP2024/070413 (WO 2025/021644A1 ), filed on Jul. 18, 2024, and claims benefit to German Patent Application No. DE 10 2023 119 566.2, filed on Jul. 25, 2023. The aforementioned applications are hereby incorporated by reference herein.

### FIELD

The invention relates to a method for replacing a set of cutting parameters for producing a cutting edge by means of a laser cutting machine with an optimized set of cutting parameters and a laser cutting machine.

### BACKGROUND

Typically, a set of cutting parameters is used to produce a cutting edge with a laser cutting machine. The set of cutting parameters may also be referred to as a set of setting parameters, a set of device setting parameters or a set of scattering parameters, in particular for the laser cutting machine for producing the cutting edge. Producing the cutting edge can also be referred to as cutting the workpiece.

The set of cutting parameters typically includes adjustment parameters for setting the laser machine, which in particular have a direct influence on the quality of the cutting edge produced.

The set of cutting parameters, in particular its values, often depends on the properties of the workpiece. The properties of the workpiece can be, for example, a material and/or a thickness of the workpiece. With a suitable selection of the set of cutting parameters, in particular its values, the laser cutting machine can produce a cutting edge that is completely or almost free of machining errors. With an unsuitable selection of the set of cutting parameters, in particular its values, machining errors, such as burrs or roughening of the cutting edge, may occur in such a way that the produced cutting edge must be reworked or the workpiece will become unusable.

DE 10 2019 127 323 A1 discloses a laser machining system for performing a machining process on a workpiece by means of a laser beam. The laser machining system comprises a sensor unit for monitoring the machining process. The laser machining system comprises a computing unit that outputs control data to a control unit of the laser machining system in order to optimize the machining process in each state through a corresponding control action and to maintain it in the optimized state.

### SUMMARY

In an embodiment, the present disclosure provides a method for replacing a set of cutting parameters for producing a cutting edge with a laser cutting machine with an optimized set of cutting parameters, the method comprising producing the cutting edge with the laser cutting machine using a set of cutting parameters, wherein the cutting edge has a machining error. The method further comprises classifying the machining error according to a type of machining error, generating several modified sets of cutting parameters based on the classification of the machining error, and producing further cutting edges with the laser cutting machine using the modified sets of cutting parameters. Each modified set of cutting parameters is used to produce one further cutting edge. The method further comprises creating an evaluation of the further cutting edges by rating an occurrence of machining errors for each of the further cutting edges, ascertaining which of the further cutting edges was evaluated as best in the evaluation of the further cutting edges, and replacing the set of cutting parameters with the optimized set of cutting parameters. The optimized set of cutting parameters is based on the modified set of cutting parameters with which the ascertained further cutting edge that was evaluated as best was produced.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic flow diagram of a method for replacing a set of cutting parameters for producing a cutting edge by means of a laser cutting machine with an optimized set of cutting parameters;

FIG. 2 illustrates a schematic view of a laser cutting machine configured to perform a method for replacing a set of cutting parameters for producing a cutting edge with an optimized set of cutting parameters;

FIG. 3 illustrates a schematic view of a cutting edge produced with the laser cutting machine of FIG. 2; and

FIG. 4 illustrates a schematic view of further cutting edges produced with the laser cutting machine of FIG. 2 and a schematic view of an evaluation of the further cutting edges.

### DETAILED DESCRIPTION

In an embodiment, the present disclosure provides a method for replacing a set of cutting parameters which enables cost-effective production of cutting edges. Furthermore, an embodiment of the present disclosure provides a laser cutting machine designed to carry out the method.

A method according to the present disclosure is designed to replace a set of cutting parameters for producing a cutting edge by means of a laser cutting machine with an optimized set of cutting parameters. The method has the following steps: a1) producing the cutting edge by means of the laser cutting machine using the set of cutting parameters, wherein the cutting edge has a machining error, b) classifying the machining error according to the type of machining error, c) generating several, in particular 5 or 10, modified sets of cutting parameters based on the classification, d) producing further cutting edges by means of the laser cutting machine using the modified sets of cutting parameters, wherein each modified set of cutting parameters is used to produce one further cutting edge, e) creating an evaluation of the further cutting edges by rating an occurrence of machining errors for each of the further cutting edges, f1) ascertaining a further cutting edge evaluated as best in the evaluation of the further cutting edges, g) replacing the set of cutting parameters with the optimized set of cutting parameters, wherein the optimized set of cutting parameters is based on the modified set of cutting parameters with which the further cutting edge ascertained, in particular in step f1), was produced.

Advantageously, the method is carried out when needed, in particular when a machining error occurs, which is why no large amounts of data are generated when producing cutting edges and why no powerful computing resources are required for producing cutting edges. This allows cutting edges to be produced using cost-effective computing resources. Therefore, the method enables cost-effective production of cutting edges.

The set of cutting parameters can comprise a number, in particular 1 to 10, of cutting parameters. The optimized set of cutting parameters can include a number, in particular 1 to 10, of cutting parameters. The modified set of cutting parameters can comprise a number, in particular 1 to 10, of cutting parameters. The number of cutting parameters of the set of cutting parameters, the number of cutting parameters of the optimized set of cutting parameters and the number of cutting parameters of the modified set of cutting parameters can be the same.

The set of cutting parameters can be a subset of a set of setting parameters of the laser cutting machine.

A cutting edge produced by means of the optimized set of cutting parameters can have no machining error or a reduced machining error compared to a cutting edge produced with the set of cutting parameters.

The optimized set of cutting parameters can differ from the set of cutting parameters in at least one value of a cutting parameter. For example, a value of a cutting parameter of the optimized set of cutting parameters can be smaller or larger than a value of the cutting parameter of the set of cutting parameters.

The machining error can be classified by a user.

Classifying can be described as classification, categorization, assignment or ascertaining. The type of machining error can be referred to as the class of machining error. Several classifiable types of machining errors can be predefined, wherein the classification of the machining error is a selection of a type of machining error from the predefined several classifiable types of machining errors.

If the cutting edge has several different types of machining errors, classifying the machining error can be classifying the dominant machining error according to a type of dominant machining error.

Generating the modified sets of cutting parameters can comprise changing the set of cutting parameters. In other words, any modified set of cutting parameters can be obtained, in particular acquired, by changing the set of cutting parameters. The change can be made depending on the classification of the machining error, in particular the classified type of machining error. The classification of the machining error, in particular the classified type of machining error, can define at least one cutting parameter of the set of cutting parameters to be changed. The change can be called a modification.

The several modified sets of cutting parameters can differ from each other, in particular in a number of the cutting parameters and/or in a value of the cutting parameters.

The evaluation can include the rating of the occurrence of machining errors from each of the further cutting edges. The rating of the occurrence of machining errors can be a rating of a severity and/or a frequency of the machining errors.

For example, a further cutting edge can receive a poor rating due to a seriously pronounced and/or frequently occurring machining error. For example, a further cutting edge received a good rating due to a slightly pronounced and/or minor machining error.

The further cutting edge evaluated as best can have no machining errors. Alternatively, the further cutting edge evaluated as best can be the further cutting edge with the least pronounced and/or least occurring machining error.

In an embodiment of the method, the classifying in step b) is computer-implemented classifying. The classifying can be carried out by a control device, in particular the laser cutting machine. The control device can have, in particular be, a computing device, a control unit, a microcontroller, and/or a computer. Classifying can be performed locally, in particular by the laser cutting machine or by a local server, or by means of cloud computing.

In an embodiment of the method, the method comprises the step after step a1) of: a2) transmitting a material of a workpiece having the cutting edge. The classifying in step b) is carried out based on the transmitted material.

The method can include the steps of: a0) specifying a number of types of machining errors and a3) limiting the number of types of machining errors based on the transmitted material. The limited number of types of machining errors can include those types of machining errors that can occur when producing a cutting edge in the transmitted material using a laser cutting machine. The limited number of types of machining errors can not include those types of machining errors that cannot occur when producing a cutting edge in the transmitted material using a laser cutting machine.

The classifying in step b) based on the transmitted material can mean that, in particular, only a limited number of types of machining errors are available for classifying. In other words, the type of machining errors classified in step b) can be, in particular, only one type of machining errors from the limited number of types of machining errors.

The material of the workpiece can be mild steel, stainless steel, aluminum, copper, or brass.

If the classifying of the machining error is computer-implemented, the transmitting of the material in step a2) can be a transmission to the control device. If the machining error is classified by a user, the transmitting of the material in step a2) can be a transmission to the user. If the machining error is classified by a user, alternatively or additionally, the transmitting of the material in step a2) can be transmission to a display for displaying the limited number of types of machining errors in step a3), wherein the display is configured to perform the step a3).

In an embodiment of the method, the cutting edge in step a1) is produced using a process gas. After step a1), the method includes the step of: a6) transmitting the process gas used in producing the cutting edge. The classifying in step b) is based on the transmitted process gas.

The method can include the steps of: a0) specifying a number of types of machining errors and a7) limiting the number of types of machining errors based on the transmitted process gas. The limited number of types of machining errors can include those types of machining errors that can occur when producing a cutting edge by means of a laser cutting machine using the transmitted process gas. The limited number of types of machining errors can not include those types of machining errors that cannot occur when producing a cutting edge by means of a laser cutting machine using the transmitted process gas.

The classifying step b) based on the transmitted process gas can mean that, in particular, only a limited number of types of machining errors are available for classifying. In other words, the type of machining errors classified in step b) can be, in particular, only one type of machining errors from the limited number of types of machining errors.

The process gas can be nitrogen or oxygen.

If the classifying of the machining error is computer-implemented, the transmitting of the process gas in step a6) can be a transmission to the control device. If the machining error is classified by a user, the transmitting of the process gas in step a6) can be a transmission to the user. If the machining error is classified by a user, alternatively or additionally, the transmitting of the process gas in step a6) can be transmission to a display for displaying the limited number of types of machining errors in step a7), wherein the display is configured to perform the step a7).

In an embodiment of the method, the method after step a1) includes the step of: a4) creating digital image data of the machining error with a, in particular digital, camera and/or a5) uploading digital image data of the machining error. The classifying in step b) is carried out based on the digital image data.

In an embodiment of the method, the classifying in step b) is carried out by means of an image recognition algorithm, an image comparison algorithm, and/or a machine learning algorithm. The image recognition algorithm can include, in particular be, feature extraction and/or feature reduction. The machine learning algorithm can include, in particular be, a trained neural network. In particular, the image recognition algorithm, the image comparison algorithm and/or the machine learning algorithm can classify the machining error by analyzing the digital image data.

In an embodiment of the method, the rating in step e) is a computer-implemented rating or a rating by a user.

If the rating is performed by a user, creating the evaluation of the further cutting edges in step e) can comprise displaying a rating scale for each further cutting edge and detecting the rating using the rating scale for each further cutting edge. The rating can comprise the user entering the rating into the rating scale for each further cutting edge.

If the rating is a computer-implemented rating, creating the evaluation of the further cutting edges in step e) can include the steps of: creating digital image data of each further cutting edge using a camera and values of the occurrence of machining errors for each of the further cutting edges by means of an analysis, in particular a computer-implemented analysis, of the digital image data. The analysis of the digital image data can comprise an application of an image recognition algorithm, an image comparison algorithm and/or a machine learning algorithm, in particular to the digital image data. The image recognition algorithm can include, in particular be, feature extraction and/or feature reduction. The machine learning algorithm can include, in particular be, a trained neural network.

In an embodiment of the method, the type of machining error of the cutting edge is a burr, a beam break, a melt tipping over, a slag adhesion, a wavy cut start, a groove trailing edge, a roughening, a pitting, a spontaneous combustion, slag formation, a welding of the cutting edge, a cutting surface discoloration, a cutting edge discoloration, a corner discoloration, a corner discoloration and/or a cut end discoloration.

In an embodiment of the method, if a single further cutting edge is ascertained in step f1), the optimized set of cutting parameters is equal to the modified set of cutting parameters with which the ascertained further cutting edge was produced. Alternatively, if several further cutting edges are ascertained in step f1), the method includes the step after step f1) of: f2) creating the optimized set of cutting parameters by calculating the mean value of the modified sets of cutting parameters with which the several further cutting edges ascertained were produced.

In an embodiment of the method, generating several modified sets of cutting parameters in step c) is carried out by applying a predefined optimization rule to the set of cutting parameters.

The predefined optimization rule can be a rule for how to change the set of cutting parameters, in particular its values and/or its cutting parameters, to generate the several modified sets of cutting parameters.

The redefined optimization rule can be assigned to the type of machining error classified in step b).

For example, the type of machining error classified in step b) can be a beam break, a spontaneous combustion or a roughening and the set of cutting parameters can include a feed, wherein the predefined optimization rule associated with the beam break, the spontaneous combustion or the roughening can comprise a reduction of a value of the feed, for example by 4%, 6%, 8%, 10%, 12%, or 14%, so that a number, in particular six, of modified sets of cutting parameters are generated by the reduction of the value of the feed of the set of cutting parameters.

For example, the type of machining error classified in step b) can be a melt tipping over or a slag adhesion and the set of cutting parameters can include a focal position, wherein the predefined optimization rule associated with the melt tipping over or the slag adhesion can comprise a change in a value of the focal position, for example by +2 mm, +1.5 mm, +1 mm, +0.5 mm, −0.5 mm, −1 mm, −1.5 mm, or −2 mm, so that a number, in particular eight, of modified sets of cutting parameters are generated by changing the value of the value of the focal position of the set of cutting parameters. The abbreviation mm can refer to the unit millimeter.

For example, the type of machining error classified in step b) can be a wavy cut start and the set of cutting parameters can include a nozzle-workpiece distance, wherein the predefined optimization rule associated with the wavy cut start can comprise a change in a value of the nozzle-workpiece distance, for example by +0.5 mm, +0.3 mm, +0.15 mm, −0.15 mm, −0.3 mm, or −0.5 mm, so that a number, in particular six, of modified sets of cutting parameters are generated by changing the value of the nozzle-workpiece distance of the set of cutting parameters.

For example, the type of machining error classified in step b) can be a cutting surface discoloration and the set of cutting parameters can comprise a gas pressure, wherein the predefined optimization rule associated with the cutting surface discoloration can comprise an increase in a value of the gas pressure, for example by +5 bar, +4 bar, +3 bar, +2 bar and +1 bar, so that a number, in particular five, of modified sets of cutting parameters are generated by increasing the value of the gas pressure of the set of cutting parameters.

For example, the type of machining error classified in step b) can be pitting and the set of cutting parameters can comprise a gas pressure, wherein the predefined optimization rule associated with the pitting can comprise a change in a value of the gas pressure, for example by +0.5 bar, +0.2 bar, +0.1 bar, −0.1 bar, −0.2 bar, or −0.5 bar, so that a number, in particular six, of modified sets of cutting parameters are generated by changing the value of the gas pressure of the set of cutting parameters.

The predefined optimization rule can include, in particular, a heuristic, an experience rule and/or a machine learning method.

The predefined optimization rule can change a value of one cutting parameter of the set of cutting parameters and subsequently change a value of another cutting parameter of the set of cutting parameters.

The several modified sets of cutting parameters can be generated in a cascade or interactively.

A number of optimization rules can be predefined, wherein each optimization rule is assigned to one, in particular a single, type of machining error, which can preferably be classified in step b). The number of optimization rules and a number of types of machining errors, in particular those classifiable in step b), can be the same.

The generating of several modified sets of cutting parameters of step c) can comprise selecting the predefined optimization rule associated with the type of machining error classified in step b).

In an embodiment of the method, the set of cutting parameters has at least one cutting parameter from a set of focus diameter, laser power, nozzle-focus distance, nozzle-workpiece distance, feed, gas pressure, nozzle diameter, and gas type. Generating several modified sets of cutting parameters in step c) comprises changing the at least one cutting parameter, in particular a value of the at least one cutting parameter.

A laser cutting machine according to the present disclosure is designed to carry out a method described above. The laser cutting machine can include a control device for carrying out the method described above, in particular for classifying the machining error according to a type of machining error. The control device can include, in particular be, a computing device, a microcontroller, a computer, a production control system, a manufacturing execution system, a programmable logic controller, and/or an IPC-based controller.

Further advantages and advantageous embodiments of the present disclosure can be gathered from the following drawings and the description thereof. All features disclosed in the drawings and the description thereof can be essential to the present disclosure both on their own and in any desired combination with one another.

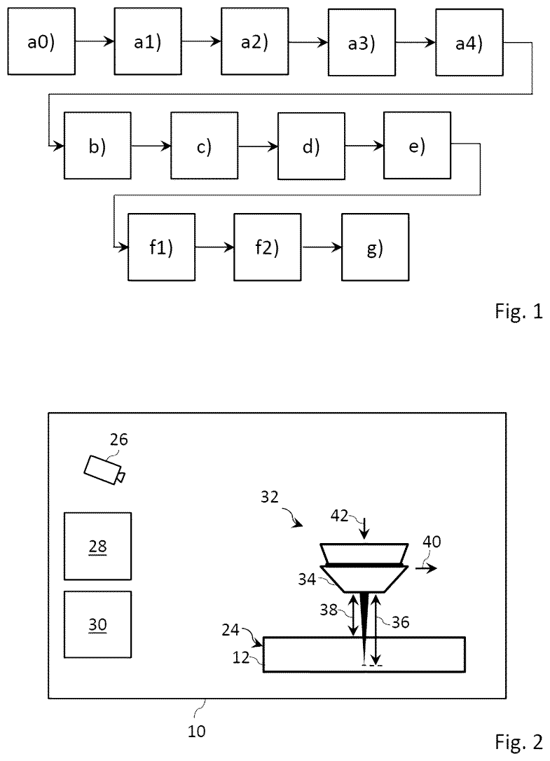

FIG. 1 illustrates a flow diagram of a method for replacing a set of cutting parameters for producing a cutting edge by means of a laser cutting machine with an optimized set of cutting parameters. The optimized set of cutting parameters differs from the set of cutting parameters in at least one value of a cutting parameter.

The method includes the step of: a0) specifying a number of types of machining errors. The predefined types of machining errors can be a burr, a beam break, a melt tipping over, a slag adhesion, a wavy cut start, a groove trailing edge, a roughening, a pitting, a spontaneous combustion, slag formation, a welding of the cutting edge, a cutting surface discoloration, a cutting edge discoloration, a corner discoloration, a corner discoloration and/or a cut end discoloration.

The method includes the step of: a1) producing the cutting edge by means of the laser cutting machine using the set of cutting parameters, wherein the cutting edge has a machining error. The set of cutting parameters includes a number of setting parameters of the laser cutting machine that are used to produce the cutting edge.

The method includes the step of: a2) transmitting a material of a workpiece having the cutting edge. The laser cutting machine has a sensor to detect the material. The sensor detects and transmits the material of the workpiece. Alternatively, a user of the laser cutting machine can transmit the material of the workpiece.

In an embodiment, the cutting edge in step a1) is produced using a process gas and the method after step a1) includes the step of: a6) transmitting the process gas used in producing the cutting edge.

The method includes the step of: a3) limiting the number of types of machining errors based on the transmitted material. The limited number of types of machining errors includes those types of machining errors that can occur when producing a cutting edge in the material transmitted using a laser cutting machine.

The method includes the step of: a4) creating digital image data of the machining error with a digital camera.

The method includes the step of: b) computer-implemented classification of the machining error depending on a type of machining error based on the digital image data of the machining error and based on the transmitted material.

In an embodiment, the classifying in step b) is carried out based on a transmitted process gas if the process gas used to produce the cutting edge was transmitted.

The classified type of machining error is not a type of machining error that is excluded based on the transmitted material.

The classifying is carried out by a computing device on the laser cutting machine. The classifying is carried out using a machine learning algorithm. The machine learning algorithm is a trained neural network that classifies the type of machining error.

The method includes the step of: c) generating several, in particular 5 or 10, modified sets of cutting parameters based on the classification. Each modified set of cutting parameters is obtained by changing the values of the set of cutting parameters.

A predefined optimization rule is assigned to the classified type of machining error. The generating of several modified sets of cutting parameters in step c) is carried out by applying the predefined optimization rule to the set of cutting parameters. The predefined optimization rule is a rule for how to change values of the set of cutting parameters to generate the several modified sets of cutting parameters.

The several modified sets of cutting parameters differ from each other in at least one value of the cutting parameters.

The method includes the step of: d) producing further cutting edges by means of the laser cutting machine using the modified sets of cutting parameters, wherein each modified set of cutting parameters is used to produce a further cutting edge.

The method includes the step of: e) creating an evaluation of the further cutting edges by rating an occurrence of machining errors for each of the further cutting edges. The rating of the occurrence of machining errors is a rating of a severity and/or a frequency of the machining errors of each of the other cutting edges. The further cutting edge evaluated as best can have no machining errors. Alternatively, the best-rated further cutting edge can be the further cutting edge with the least pronounced and/or least occurring machining error.

The rating is a computer-implemented rating. Creating the evaluation of the further cutting edges comprises creating digital image data of each further cutting edge using a camera and evaluating the occurrence of machining errors for each of the further cutting edges using a computer-implemented analysis of the digital image data. The computer-implemented analysis of digital image data is an application of a machine learning algorithm to the digital image data. The machine learning algorithm is a trained neural network for rating the occurrence of machining errors.

The method includes the step of: f1) ascertaining a further cutting edge evaluated as best in the evaluation of the further cutting edges.

If a single further cutting edge is ascertained in step f1), the optimized set of cutting parameters is equal to the modified set of cutting parameters with which the ascertained further cutting edge was produced.

If several further cutting edges are ascertained in step f1), the method includes the step after step f1) of: f2) creating the optimized set of cutting parameters by calculating the mean value of the modified sets of cutting parameters with which the several further cutting edges ascertained were produced. In particular, the values of the cutting parameters of the optimized set of cutting parameters are equal to an average of the values of the cutting parameters of the modified sets of cutting parameters with which the several ascertained further cutting edges were produced.

The method includes the step of: g) replacing the set of cutting parameters with the optimized set of cutting parameters, wherein the optimized set of cutting parameters is based on the modified set of cutting parameters with which the further cutting edge ascertained in the step f1) was produced.

FIG. 2 shows a laser cutting machine 10 configured to perform a method for replacing a set of cutting parameters for producing a cutting edge with an optimized set of cutting parameters.

The laser cutting machine 10 has a camera 26, a control unit 28, a display 30 and a laser cutting head 32 with a nozzle 34. The control unit 28 is designed to control the laser cutting head 32 for producing a cutting edge 12 with the laser cutting machine 10.

The control unit 28 has a set of cutting parameters for producing the cutting edge. The set of cutting parameters includes the cutting parameters of: focus diameter, laser power, nozzle-focus distance 36, nozzle-workpiece distance 38, feed 40, gas pressure 42, nozzle diameter and gas type.

Using the set of cutting parameters and further setting parameters, the cutting edge 12 is produced with the laser cutting machine 10. The production of the cutting edge 12 is a cutting of a workpiece 24. The workpiece 24 includes the cutting edge 12.

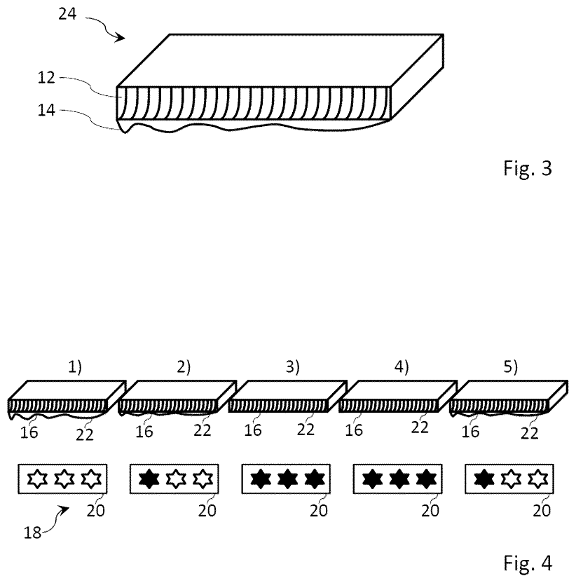

FIG. 3 shows the workpiece 24 with the cutting edge 12, which was produced with the laser machine 10 using the set of cutting parameters. The cutting edge 12 has a machining error 14 in the form of a burr. Due to an unsuitable selection of the values of the set of cutting parameters, the machining error 14 occurred.

A user of the laser cutting machine 10 transmits a material of the workpiece 24 to the control unit 28. This can be done, for example, by displaying a selection of different materials using the display 30 and selecting one of the displayed materials by the user. The control unit 28 excludes those types of machining errors that do not occur in the transmitted material. In the example shown, the transmitted material is brass and the excluded machining error is spontaneous combustion.

In an embodiment, the cutting edge was produced using a process gas in the form of nitrogen. The user of the laser cutting machine transmits the process gas in the form of nitrogen to the control unit. The control unit excludes those types of machining errors that do not occur with the transmitted process gas.

The user creates digital image data of the machining error 14 using the camera 26 of the laser cutting machine 10.

The control unit 28 analyzes the digital image data using a machine learning algorithm. The machine learning algorithm classifies the machining error 14 as a burr based on the digital image data and the transmitted material.

In an embodiment, the machining error and the type of machining error can be a beam break, a melt tipping over, a slag adhesion, a wavy cut start, a groove trailing edge, a roughening, a pitting, slag formation, a welding of the cutting edge, a cutting surface discoloration, a cutting edge discoloration, a corner discoloration, a corner discoloration or a cut end discoloration.

The control unit 28 has predefined optimization rules, one of the predefined optimization rules being assigned to each classifiable type of machining error.

In the example shown, the classified type of machining error 14 is the burr and the set of cutting parameters includes gas pressure 42. The predefined optimization rule associated with the burr comprises an increase of a value of the gas pressure 42 by +1.5 bar, +1.2 bar, +0.9 bar, +0.6 bar and +0.3 bar.

The control unit 28 generates several modified sets of cutting parameters based on the classifying by applying the predefined optimization rule associated with the burr to the set of cutting parameters. This creates five modified sets of cutting parameters that differ from each other in a value of the gas pressure 42.

Using the modified sets of cutting parameters, further cutting edges 16 are produced with the laser cutting machine, wherein each modified set of cutting parameters is used to produce at least one further cutting edge 16. This produces at least five further cutting edges 16.

FIG. 4 illustrates the further cutting edges 16. For better understanding, the other cutting edges 16 are labeled with the numbers 1) to 5).

The further cutting edge 16 with the number 1) was produced with a gas pressure 42 that was 0.3 bar higher than that of the cutting edge 12. The further cutting edge 16 with the number 2) was produced with a gas pressure 42 that was 0.6 bar higher than that of the cutting edge 12. The further cutting edge 16 with the number 3) was produced with a gas pressure 42 that was 0.9 bar higher than that of the cutting edge 12. The further cutting edge 16 with the number 4) was produced with a gas pressure 42 that was 1.2 bar higher than that of the cutting edge 12. The further cutting edge 16 with the number 5) was produced with a gas pressure 42 that was 1.5 bar higher than that of the cutting edge 12.

By rating an occurrence of machining errors 22 for each of the further cutting edges 16, an evaluation 18 of the further cutting edges 16 is created. The rating is a rating by a user.

On the display 30 in the form of a touchscreen monitor, a rating scale 20 is displayed for each further cutting edge 16, see FIG. 4. The rating scale 20 has three stars. The user evaluates an occurrence, in particular a severity and a frequency, of machining errors 22 for each of the further cutting edges 16 and enters their rating into the rating scale 20.

The further cutting edge 16 with the number 1) has a very pronounced machining error 22, which is why it receives a poor rating from the user. The user selects no stars on the rating scale 20.

In the further cutting edge 16 with the number 2), the machining error 22 is slightly pronounced, which is why it receives an average rating from the user. The user selects one star on the rating scale 20.

The further cutting edge 16 with the number 3) does not have any machining errors, which is why it receives a good rating from the user. The user selects three stars on the rating scale 20.

The further cutting edge 16 with the number 4) does not have any machining errors, which is why it receives a good rating from the user. The user selects three stars on the rating scale 20.

In the further cutting edge 16 with the number 5), the machining error 22 is slightly pronounced, which is why it receives an average rating from the user. The user selects one star on the rating scale 20.

In an embodiment, the evaluation can be a computer-implemented rating. For this purpose, the user creates digital image data of each further cutting edge using the laser machine's camera, wherein the control unit evaluates the occurrence of machining errors for each of the further cutting edges by analyzing the digital image data.

The control unit 28 ascertains a further cutting edge 16 which is evaluated as best in the evaluation 18 of the further cutting edges 16. These are the further cutting edges 16 with the numbers 3) and 4). The control unit 28 has ascertained several further cutting edges 16 and the control unit 28 creates the optimized set of cutting parameters by calculating the mean value of the modified sets of cutting parameters with which the ascertained further cutting edges 16 with the numbers 3) and 4) were produced. The mean value of the gas pressure 42 of the modified sets of cutting parameters of the further cutting edge 16 with the numbers 3) and 4) is a gas pressure 42 increased by 1.05 bar compared to the set of cutting parameters.

The optimized set of cutting parameters differs from the set of cutting parameters in the value of the gas pressure 42. The value of the gas pressure 42 of the optimized set of cutting parameters is 1.05 bar higher than the value of the gas pressure 42 of the set of cutting parameters. Thus, the optimized set of cutting parameters is based on the modified set of cutting parameters with which the ascertained further cutting edge 16 was produced.

In an embodiment, for example, only the further cutting edge with the number 3) can be the further cutting edge evaluated as best. In this case, the optimized set of cutting parameters is equal to the modified set of cutting parameters with which the ascertained further cutting edge with the number 3) was produced. In this case, the value of the gas pressure of the optimized set of cutting parameters is 0.9 bar higher than the value of the gas pressure of the set of cutting parameters.

The control unit 28 replaces the set of cutting parameters with the optimized set of cutting parameters. Subsequent cutting edges produced with the laser machine are produced using the set of cutting parameters, wherein the set of cutting parameters is equal to the optimized set of cutting parameters.

As the embodiments shown and explained make clear, the present disclosure provides a method and a laser cutting machine which enables cost-effective production of cutting edges.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for replacing a set of cutting parameters for producing a cutting edge with a laser cutting machine with an optimized set of cutting parameters, the method comprising:
a1) producing the cutting edge with the laser cutting machine using a set of cutting parameters, wherein the cutting edge has a machining error;
b) classifying the machining error according to a type of machining error;
c) generating several modified sets of cutting parameters based on the classification of the machining error;
d) producing further cutting edges with the laser cutting machine using the modified sets of cutting parameters, wherein each modified set of cutting parameters is used to produce one further cutting edge;
e) creating an evaluation of the further cutting edges by rating an occurrence of machining errors for each of the further cutting edges;
f1) ascertaining which of the further cutting edges was evaluated as best in the evaluation of the further cutting edges;
g) replacing the set of cutting parameters with the optimized set of cutting parameters, wherein the optimized set of cutting parameters is based on the modified set of cutting parameters with which the ascertained further cutting edge that was evaluated as best was produced.

2. The method according to claim 1,
wherein the classifying in step b) is computer-implemented classifying.

3. The method according to claim 1,
wherein the method after step a1) includes a step of:
a2) transmitting a material of a workpiece having the cutting edge,
wherein the classifying in step b) is carried out based on the transmitted material.

4. The method according to claim 1,
wherein in step a1) the cutting edge is produced using a process gas,
wherein the method after step a1) includes a step of:
a6) transmitting the process gas used in producing the cutting edge,
wherein the classifying in step b) is carried out based on the transmitted process gas.

5. The method according to claim 1,
wherein the method after step a1) includes a step of:
a4) creating digital image data of the machining error with a camera, and/or
a5) uploading digital image data of the machining error,
wherein the classifying in step b) is carried out based on the digital image data.

6. The method according to claim 1,
wherein the classifying in step b) is carried out by an image recognition algorithm, an image comparison algorithm, and/or a machine learning algorithm.

7. The method according to claim 1,
wherein the rating in step e) is a computer-implemented rating or a rating by a user.

8. The method according to claim 1,
wherein the type of machining error of the cutting edge is a burr, a beam break, a melt tipping over, a slag adhesion, a wavy cut start, a groove trailing edge, a roughening, a pitting, a spontaneous combustion, slag formation, a welding of the cutting edge, a cutting surface discoloration, a cutting edge discoloration, a corner discoloration, a corner discoloration and/or a cut end discoloration.

9. The method according to claim 1,
wherein if a single further cutting edge is ascertained in step f1), the optimized set of cutting parameters is equal to the modified set of cutting parameters with which the ascertained further cutting edge was produced, or
wherein if several further cutting edges are ascertained in step f1), the method includes a step after step f1) of:
f2) creating the optimized set of cutting parameters by calculating a mean value of the modified sets of cutting parameters with which the several further cutting edges ascertained were produced.

10. The method according to claim 1,
wherein the generating of several modified sets of cutting parameters in step c) is carried out by applying a predefined optimization rule to the set of cutting parameters.

11. The method according to claim 1,
wherein the set of cutting parameters has at least one cutting parameter selected from the group consisting of a focus diameter, a laser power, a nozzle-focus distance, a nozzle-workpiece distance, a feed, a gas pressure, a nozzle diameter, and a gas type,
wherein the generating of several modified sets of cutting parameters in step c) comprises changing the at least one cutting parameter.

12. A laser cutting machine,
configured to carry out the method according to claim 1.
